(19) United States
(12) Patent Application Publication
(10) Pub. No.: US 2025/0286131 A1
(43) Pub. Date: Sep. 11, 2025

(54) ELECTROLYTE FOR RECHARGEABLE LITHIUM BATTERY AND RECHARGEABLE LITHIUM BATTERY INCLUDING THE SAME

(71) Applicant: Samsung SDI Co., Ltd., Yongin-si (KR)

(72) Inventors: Sanghyung KIM, Yongin-si (KR); TAE HYON BAE, Yongin-si (KR); Harim LEE, Yongin-si (KR); Seunghyeon SON, Yongin-si (KR); SUNDAE KIM, Yongin-si (KR); Yeji YANG, Yongin-si (KR); Sangheon LEE, Yongin-si (KR); CHEONSOO KIM, Yongin-si (KR)

(21) Appl. No.: 18/807,765

(22) Filed: Aug. 16, 2024

(30) Foreign Application Priority Data
Mar. 11, 2024 (KR) 10-2024-0033841

(51) Int. Cl. H01M 10/0567; H01M 10/0525; H01M 10/0569

(52) U.S. Cl. CPC H01M 10/0567; H01M 10/0525; H01M 10/0569; H01M 2300/004

(57) ABSTRACT

An electrolyte including a non-aqueous organic solvent, a lithium salt, a first additive, and a second additive and rechargeable lithium batteries including the electrolyte are provided. The electrolyte first additive is represented by Chemical Formula 1 and the second additive is represented by Chemical Formula 2.

### CROSS-REFERENCE TO RELATED APPLICATION

This application claims priority to and the benefit of Korean Patent Application No. 10-2024-0033841, filed on Mar. 11, 2024, in the Korean Intellectual Property Office, the entire content of which is hereby incorporated by reference.

### BACKGROUND

### 1. Field

According to one or more embodiments, the present disclosure relates to an electrolyte for a rechargeable lithium battery and a rechargeable lithium battery including the same.

### 2. Description of the Related Art

Recently, with the rapid spread of battery utilizing electronic devices, such as mobile phones, laptop computers, electric vehicles, and/or the like, there is a rapidly increasing desire or demand for rechargeable batteries with relatively high energy density and relatively high capacity. Therefore, intensive research has been conducted to improve performance of rechargeable lithium batteries.

A rechargeable lithium battery includes a positive electrode, a negative electrode, and an electrolyte, in which the positive and negative electrodes include an active material in which intercalation and deintercalation (e.g. of lithium ions) are possible. For example, the rechargeable lithium battery generates electrical energy caused by oxidation and reduction reactions if (e.g., when) lithium ions are intercalated and/or deintercalated.

A lithium salt dissolved in a non-aqueous organic solvent is utilized as the electrolyte of the rechargeable lithium battery. Characteristics of the rechargeable lithium battery are exhibited by complex reactions between the positive electrode and the electrolyte and between the negative electrode and the electrolyte. Accordingly, the utilization of an appropriate or suitable electrolyte is one of the primary and/or important variables for improvement of the performance of the rechargeable lithium battery.

### SUMMARY

One or more aspects are directed toward an electrolyte for a rechargeable lithium battery with improved stability and lifetime characteristics at high voltages.

One or more aspects are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may comprise: a non-aqueous organic solvent; a lithium salt; a first additive represented by Chemical Formula 1; and a second additive represented by Chemical Formula 2.

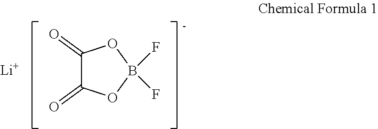

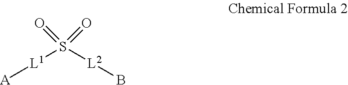

In Chemical Formula 2,
L¹ and L² may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
A and B may each independently be a substituted or unsubstituted C1 to C20 alkyl group, a substituted or unsubstituted C6 to C20 aryl group, or a substituted or unsubstituted C2 to C20 heteroaryl group, and
At least one selected from among A and B may be a group represented by Chemical Formula A.

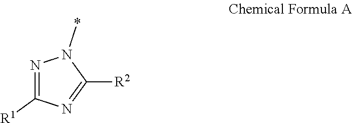

In Chemical Formula A, R¹ and R² may each independently be hydrogen, halogen, a substituted or unsubstituted C1 to C10 alkyl group, or a substituted or unsubstituted C3 to C10 cycloalkyl group. * may be a point of connection to Chemical Formula 2.

According to one or more embodiments of the present disclosure, an electrolyte for a rechargeable lithium battery may comprise: a first additive represented by Chemical Formula 1; and a second additive represented by Chemical Formula 2. An amount (e.g., amount weight) ratio of the second additive represented by Chemical Formula 2 to the first additive represented by Chemical Formula 1 may be in a range of about 1 to about 5.

According to one or more embodiments of the present disclosure, a rechargeable lithium battery may comprise: a positive electrode that includes a positive electrode active material; a negative electrode that includes a negative electrode active material; and an electrolyte. The electrolyte may include: a non-aqueous organic solvent; a lithium salt; a first additive represented by Chemical Formula 1; and a second additive represented by Chemical Formula 2.

### BRIEF DESCRIPTION OF THE DRAWINGS

FIG. 1 illustrates a simplified conceptual diagram showing a rechargeable lithium battery according to one or more embodiments of the present disclosure.

FIGS. 2-5 illustrate simplified cross-sectional views each showing a rechargeable lithium battery according to one or more embodiments of the present disclosure.

### DETAILED DESCRIPTION

In order to sufficiently understand the configuration and effect of the present disclosure, some embodiments of the present disclosure will be described with reference to the accompanying drawings. It should be noted, however, that the present disclosure is not limited to the following exemplary embodiments, and may be implemented in one or more suitable forms. Rather, the exemplary embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components are exaggerated for effectively explaining the technical contents. Like reference numerals refer to like elements throughout, and duplicative descriptions thereof is not provided the specification.

Unless otherwise specially noted in this description, the expression of singular form may include the expression of plural form. In some embodiments, unless otherwise specially noted, the phrase “A or B” may indicate “A but not B”, “B but not A”, and “A and B”.

The terms “comprises/includes,” “comprising/including,” “comprise/include,” “having,” “has,” and/or “have”, as used in this description, are intended to designate the presence of an embodied aspect, number, step (e.g., act or task), element, and/or a (e.g., any suitable) combination thereof. However, the use of these terms does not preclude or exclude the possibility of the presence or addition of one or more other components, features, numbers, steps (e.g., acts or tasks), elements, and/or a (e.g., any suitable) combination thereof.

As used herein, the term “combination thereof” may refer to a mixture, a stack, a composite, a copolymer, an alloy, a blend, or a reaction product.

In one or more embodiments, the term “layer” herein includes not only a shape formed or provided on the whole surface if (e.g., when) viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” indicates that any additional components will not materially affect the chemical, physical, optical or electrical properties of the semiconductor film.

Further, in this specification, the phrase “on a plane,” or “plan view,” indicates viewing a target portion from the top, and the phrase “on a cross-section” indicates viewing a cross-section formed by vertically cutting a target portion from the side.

### Rechargeable Lithium Battery

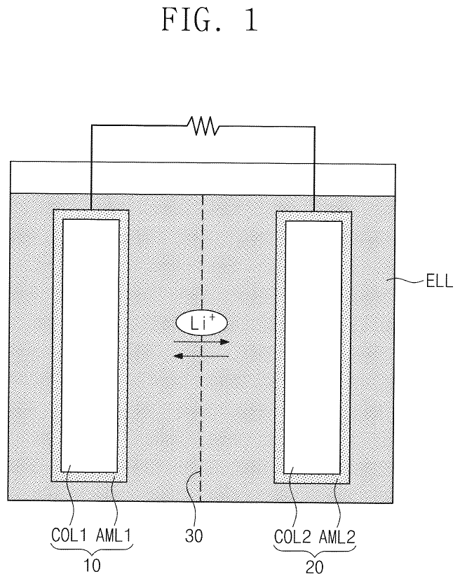

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., space apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material.

For example, the positive electrode 10 may further include an additive that can serve as a sacrificial positive electrode.

An amount of the positive electrode active material may range from about 90 wt % to about 99.5 wt % based on 100 wt % of the positive electrode active material layer AML1. Amounts of the binder and the conductive material may be about 0.5 wt % to about 5 wt % based on 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be utilized to provide an electrode with conductivity, and any suitable conductive material without causing chemical change of a battery may be utilized as the conductive material to constitute the battery. The conductive material may include, for example, a carbon-based material such as natural graphite, artificial graphite, carbon black, acetylene black, Ketjenblack, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be utilized as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from among cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented by one selected from among the following chemical formulae. LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GeO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the chemical formulae herein, A may be Ni, Co, Mn, or a combination thereof, X may be Al, Ni, Co, Mn, Cr, Fe, Mg, Sr, V, a rare-earth element, or a combination thereof, D may be O, F, S, P, or a combination thereof, G may be Al, Cr, Mn, Fe, Mg, La, Ce, Sr, V, or a combination thereof, and L¹ may be Mn, Al, or a combination thereof.

For example, the positive electrode active material may be a high nickel-based positive electrode active material having a nickel content (e.g., amount) of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of metal devoid of lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If (e.g., when) an aqueous binder is utilized as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be utilized to provide an electrode with conductivity, and any suitable conductive material without causing chemical change of a battery may be utilized as the conductive material to constitute the battery. For example, the conductive material may include a carbon-based material such as natural graphite, artificial graphite, carbon black, acetylene black, Ketjenblack, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include silicon, a silicon-carbon composite, SiOx (0<x≤2), a Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnOx (0<x≤2), e.g., SnO₂, a Sn-based alloy, or a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be utilized in combination with a carbon-based negative electrode active material.

### Separator 30

Based on type or kind of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, and polytetrafluoroethylene (e.g., Teflon), or may be a copolymer or mixture including two or more of the materials mentioned herein.

The organic material may include a polyvinylidenefluoride-based copolymer or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be utilized alone or in a mixture of two or more substances.

In some embodiments, if (e.g., when) a carbonate-based solvent is utilized, a cyclic carbonate and a chain carbonate may be mixed and utilized, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluorobis(oxalato)phosphate (LiDFOB), and lithium bis(oxalato) borate (LiBOB)

### Rechargeable Lithium Battery

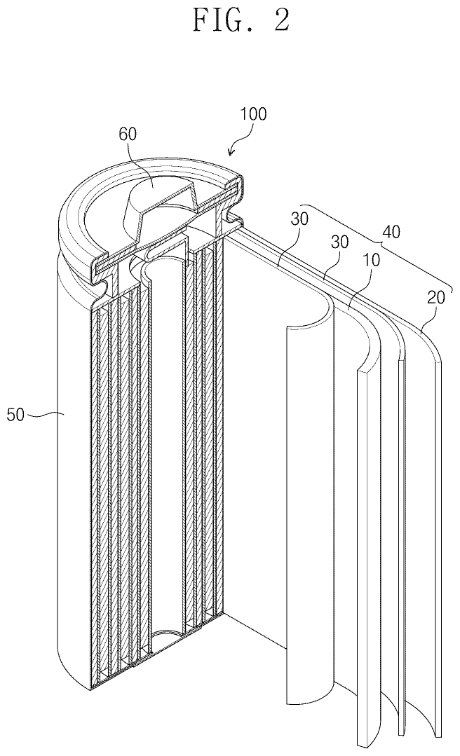

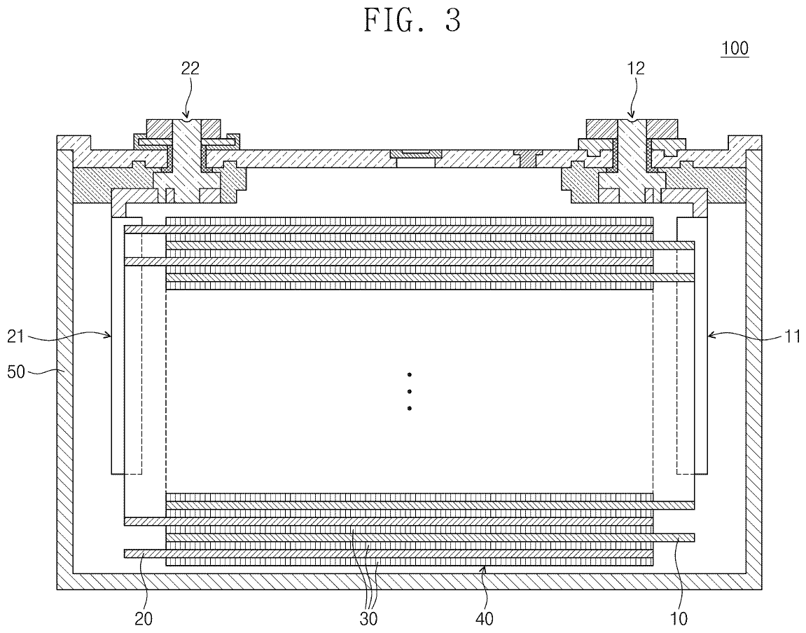

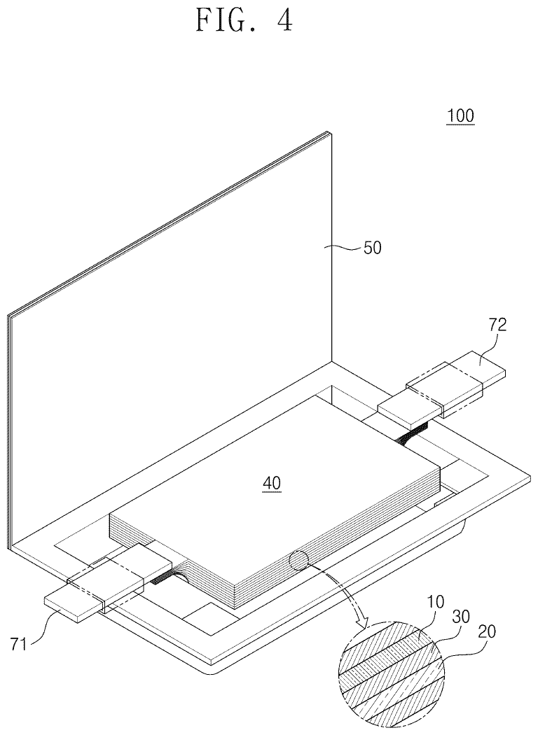

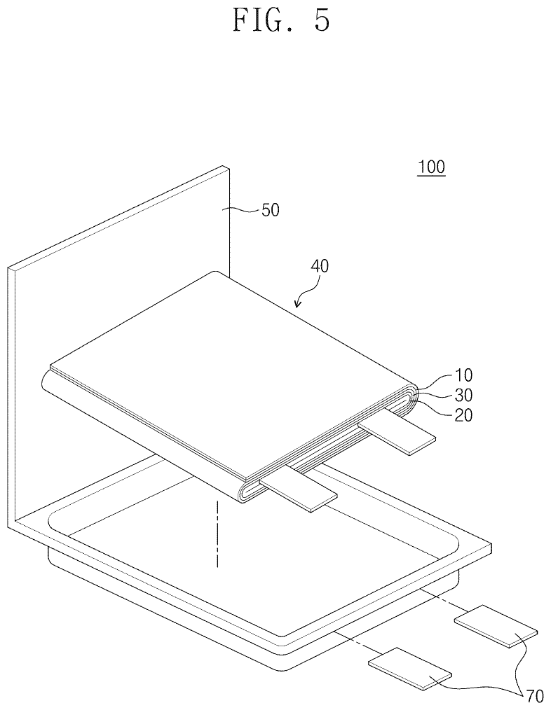

Based on shape of a rechargeable lithium battery, the rechargeable lithium battery may be classified into cylindrical, prismatic, pouch, and coin types (kinds). In FIGS. 2 to 5 illustrating simplified diagrams each showing a rechargeable lithium battery according to one or more embodiments, FIG. 2 shows a cylindrical battery, FIG. 3 shows a prismatic battery, and FIGS. 4 and 5 show pouch-type or kind batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In some embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIG. 4, the rechargeable lithium battery 100 may include a positive electrode tab 71 and a negative electrode tab 72, which serve as an electrical path for externally inducing a current generated in the electrode assembly 40. As shown in FIG. 5, the rechargeable lithium battery 100 may include an electrode tabs 70, which serve as an electrical path for externally inducing a current generated in the electrode assembly 40.

The following will describe in more detail an electrolyte for a rechargeable lithium battery according to some embodiments of the present disclosure.

An electrolyte for a rechargeable lithium battery according to one or more embodiments may include a non-aqueous organic solvent, a lithium salt, a first additive represented by Chemical Formula 1, and a second additive represented by Chemical Formula 2.

The electrolyte may be prepared by a mixing process in which the lithium salt is dissolved in the non-aqueous organic solvent, and the first additive and the second additive are added to mix. The electrolyte mixing process is widely known in electrolyte fabrication field, and a person skilled in the art will be able to appropriately or suitably select and utilize.

The non-aqueous organic solvent may include at least one selected from among ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In one or more embodiments, the non-aqueous organic solvent may be a mixed (e.g., mixture) solvent of ethylene carbonate (EC), propyl carbonate (propylene carbonate) (PC), and propyl propionate (PP).

For example, the ethylene carbonate (EC) may be included in an amount of about 5 vol % to about 20 vol % relative to the total volume of 100 vol % of the non-aqueous organic solvent. The propylene carbonate (PC) may be included in an amount of about 10 vol % to about 30 vol % relative to the total volume of the non-aqueous organic solvent. The propyl propionate (PP) may be included in an amount of about 50 vol % to about 80 vol % relative to the total volume of 100 vol % of the non-aqueous organic solvent.

In one or more embodiments, the lithium salt may include LiPF₆.

The lithium salt may have a concentration of about 0.1 M to about 2.0 M. For example, the lithium salt may have a concentration of equal to or greater than about 0.5 M or equal to or greater than 1.0 M. The lithium salt may have a concentration of equal to or less than about 2.0 M, equal to or less than about 1.7 M or equal to or less than about 1.5 M. In the present disclosure, if (e.g., when) the lithium salt has a concentration of about 0.1 M to about 2.0 M, the electrolyte may appropriately or suitably maintain its conductivity and viscosity.

The first additive according to one or more embodiments of the present disclosure may be lithium difluoro (oxalato) borate, or LiDFOB, represented by Chemical Formula 1.

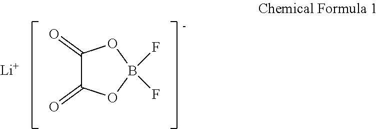

As the first additive has a halogen component such as fluorine, LiF generated during charge-discharge procedures may form a strong film on positive and negative electrodes. Thus, the first additive may effectively contribute to lifetime characteristics of a lithium battery.

The first additive may be included in an amount of about 0.5 wt % to about 1 wt % relative to the total weight of 100 wt % of the electrolyte. For example, the first additive may be present in an amount of about 1 wt % to about 2 wt % relative to the total weight of 100 wt % of the electrolyte. If (e.g., when) an amount of the first additive is less than the disclosed ranges, there may be a problem where a film cannot be provided sufficiently on lithium-based positive and negative electrodes, and if (e.g., when) an amount of the first additive is greater than the disclosed ranges, there may be a problem where battery capacity and lifetime are reduced due to an increase in resistance of positive and negative electrodes.

The second additive according to one or more embodiments of the present disclosure may be represented by Chemical Formula 2.

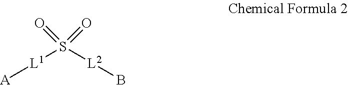

In Chemical Formula 2,
L¹ and L² may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group.
A and B may each independently be a substituted or unsubstituted C1 to C20 alkyl group, a substituted or unsubstituted C6 to C20 aryl group, or a substituted or unsubstituted C2 to C20 heteroaryl group.

At least one selected from among A and B may be a group represented by Chemical Formula A.

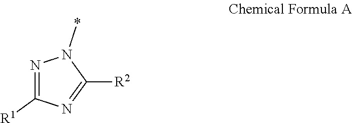

In Chemical Formula A,
R¹ and R² may each independently be hydrogen, halogen, a substituted or unsubstituted C1 to C10 alkyl group, or a substituted or unsubstituted C3 to C10 cycloalkyl group.

For example, at least one selected from among L¹ and L² may be a substituted or unsubstituted C1 to C5 alkylene group.

For example, L¹ and L² may each independently be a substituted or unsubstituted C1 to C5 alkylene group.

For example, at least one selected from among L¹ and L² may be a substituted or unsubstituted C2 to C5 alkylene group.

For example, L¹ and L² may each independently be a substituted or unsubstituted C2 to C5 alkylene group.

The sulfone group included in Chemical Formula 2 may form a film on a surface of the positive electrode to suppress or reduce decomposition of a positive electrode active material, and thus it may be possible to inhibit or reduce gas generation and dissolution of transition metal due to the decomposition of the positive electrode active material.

The second additive represented by Chemical Formula 2 may strengthen a solid electrolyte interface (SEI) layer on a surface of the negative electrode, while preventing or reducing deterioration of the SEI layer or dissolution of transition metals from the positive electrode during high-temperature storage.

For example, Chemical Formula 2 may be represented by Chemical Formula 2-1.

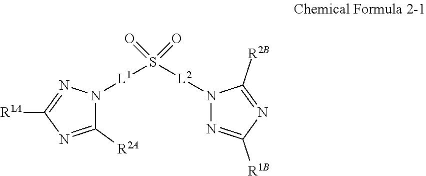

In Chemical Formula 2-1,
L¹ and L² may each independently be a substituted or unsubstituted C2 to C5 alkylene group.
R^{1A}, R^{1B}, R^{2A}, and R^{2B} may each independently be hydrogen, halogen, a substituted or unsubstituted C1 to C10 alkyl group, or a substituted or unsubstituted C3 to C10 cycloalkyl group.

In one or more embodiments, the second additive may be selected from among compounds listed in Group 1.

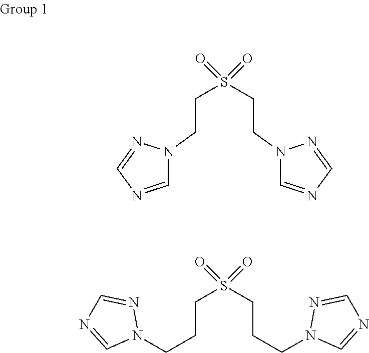 [SMILES: O=S(=O)(CCn1cncn1)CCn1cncn1 ; O=S(=O)(CCCn1cncn1)CCCn1cncn1]

The second additive may be included in an amount of about 0.5 wt % to about 5 wt % relative to the total weight of 100 wt % of the electrolyte. For example, the second additive may be present in an amount of about 1 wt % to about 3 wt % relative to the total weight of 100 wt % of the electrolyte. If (e.g., when) the second additive has an amount within the disclosed ranges, an increase in resistance at high temperatures may be prevented or reduced to achieve a rechargeable lithium battery with improved lifetime and output characteristics.

If (e.g., when) the second additive is utilized in combination with a fluorinated lithium salt additive (e.g., the first additive), a synergic effect may be produced. The combination of the first additive and the second additive may cause a suppression of gas generation, an increase in high-temperature storage performance, and an improvement in high-temperature and room-temperature cycle stability of lithium batteries.

For example, in the electrolyte according to the present disclosure, an effect of HF generation reduction due to salt stabilization led by the first additive and an effect of positive electrode metal coordination of a triazole group may be produced concurrently (e.g., simultaneously) with each other, and thus dissolution of transition metal at high-temperature storage may be suppressed or reduced to effectively prevent or reduce positive electrode degradation.

In one or more embodiments of the present disclosure, an electrolyte for a rechargeable lithium battery may include a first additive represented by Chemical Formula 1 and a second additive represented by Chemical Formula 2, and an amount ratio of the second additive to the first additive may range from about 1 to about 5. The electrolyte for a rechargeable lithium battery according to one or more embodiments may further include a non-aqueous organic solvent and a lithium salt.

In the electrolyte, an amount of the second additive may be greater than that of the first additive. An amount ratio of the second additive to the first additive may range from about 1 to about 5. According to one or more embodiments, the amount ratio of the second additive to the first additive may range from about 1 to about 3.

If (e.g., when) the amount ratio of the second additive to the first additive is less than the disclosed ranges, Coulombic efficiency may abruptly decrease, and if (e.g., when) the amount ratio of the second additive to the first additive is greater than the disclosed ranges, no protective layer may be provided sufficiently on a surface of lithium-based metal.

In one or more embodiments of the present disclosure, a rechargeable lithium battery may include a positive electrode that includes a positive electrode active material, a negative electrode that includes a negative electrode active material, and an electrolyte, and the electrolyte may include a non-aqueous organic solvent, a lithium salt, a first additive represented by Chemical Formula 1, and a second additive suppressed or reduced by Chemical Formula 2.

In a rechargeable lithium battery according to one or more embodiments of the present disclosure, a non-aqueous electrolyte may be decomposed during an initial charge-discharge to form a film having passivation ability on surfaces of positive and negative electrodes to improve high-temperature storage characteristics. The film may be deteriorated due to acid such as HF⁻ and PF₅⁻ produced by thermal decomposition of lithium salts (LiPF₆ and/or the like) widely utilized lithium ion batteries. This acid attack may elute transition metal elements from the positive electrode and increase a surface resistance of the electrode caused by a structural change of the surface. Thus, a theoretical capacity may be reduced due to loss of metal elements which are redox (reduction and oxidation) centers, which may result in a reduction in capacity. In some embodiments, the eluted transition metal ions may be electrodeposited on the negative electrode that reacts in a strong reduction potential range. Therefore, electrons may be consumed and the film may be destroyed during the electrodeposition, and accordingly the surface of the negative electrode may be exposed to cause an additional electrolyte decomposition reaction. There may thus be an increase in resistance of the negative electrode and in irreversible capacity, and as a result, there may be a problem of each independently continuous reduction in cell capacity.

In the present disclosure, a triazole group and a sulfone group of the second additive represented by Chemical Formula 2 may provide an unshared electron pair to capture PF₅⁻ and stabilize a LiPF₆ salt, with the result that it may be possible to remove the acid led by decomposition of the lithium salt.

The rechargeable lithium battery may be applied to automotive vehicles, mobile phones, and/or any other electrical devices, but the present disclosure is not limited thereto. The rechargeable lithium battery may be suitable for chargeability or operation at high voltages. For example, the rechargeable lithium battery may have a maximum charging voltage of equal to or greater than about 4.5 V, about 4.5 V to about 4.7 V, about 4.5 V to about 4.6 V, or about 4.5 V to about 4.55 V.

The positive electrode active material of the rechargeable lithium battery may include one or more of lithium-cobalt-based oxide, lithium nickel-based oxide, lithium manganese-based oxide, lithium iron phosphate-based compounds, cobalt-free nickel-manganese-based oxide, and any combination thereof. For example, the positive electrode active material may include lithium cobalt-based oxide.

The negative electrode active material of the rechargeable lithium battery may include a carbon-based negative electrode active material, a silicon-based negative electrode active material, or any combination thereof.

The silicon-based negative electrode active material may include a core including silicon-based particles and a coating layer including amorphous carbon. The silicon-based particles may include one or more of a silicon particle, a silicon-carbon composite, SiOx (0≤x<2), and a silicon alloy.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

The following will describe Example Embodiments and Comparative Examples of the present disclosure. The following examples are only one or more possible embodiments of the present disclosure, and the present disclosure is not limited to the following examples.

### EXAMPLES AND COMPARATIVE EXAMPLES

### Example 1

### (1) Preparation of Electrolyte

1.3 M LiPF₆ was dissolved in a non-aqueous organic solvent in which ethylene carbonate (EC), propylene carbonate (PC), and propyl propionate (PP) were mixed in a volume ratio of about 10:15:75, and a first additive of 1 wt % and a second additive of 1 wt % were added to prepare an electrolyte.

A material represented by Chemical Formula 1 was utilized as the first additive.

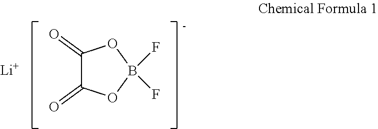

A material represented by Chemical Formula 2a was utilized as the second additive.

For example, the second additive in accordance with Chemical Formula 2a may be fabricated from the Synthesis Example described herein.

### Synthesis Example

Divinyl sulfone (1.1 mmol) mixed with 3 milliliter (mL) of acetone was added dropwise for 30 minutes to a solution in which 1H-1,2,4-triazole (2 mmol) was mixed in acetone and sufficiently stirred with sodium hydrogen carbonate (3 mmol). Afterwards, the mixture was stirred at room temperature (25° C.) for 4 hours, and precipitates were filtered. The filtered solution was recrystallized to obtain a compound of Chemical Formula 2a.

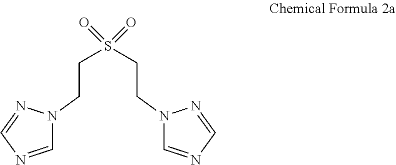 [SMILES: O=S(=O)(CCn1cncn1)CCn1cncn1]

### (2) Fabrication of Rechargeable Lithium Battery

LiCoO₂ (LCO) of 97 wt %, artificial graphite powder of 0.5 wt % as a conductive material, carbon black (Ketjen black) of 0.8 wt %, acrylonitrile rubber of 0.2 wt %, polyvinylidene fluoride (PVdF) of 1.5 wt % were mixed and added to N-methyl-2-pyrrolidone, and then the mixture was stirred for 30 minutes by utilizing a mechanical agitator to manufacture a positive electrode active material slurry. A doctor blade was utilized to coat the slurry with a thickness of about 60 micrometer (μm) on an aluminum current collector having a thickness of about 20 μm, dried in a hot-air drier for 0.5 hours at 100° C., dried again for 4 hours at 120° C. in a vacuum condition, and then roll-pressed to manufacture a positive electrode.

A negative electrode active material in which artificial graphite of 98 wt % and silicon composite were mixed in a volume ratio of 93:7, styrene-butadiene rubber (SBR) of 1 wt %, and carboxymethyl cellulose (CMC) of 1 wt % were mixed and added to distilled water, and then stirred for 60 minutes by utilizing a mechanical agitator to manufacture a negative electrode active material slurry. A doctor blade was utilized to coat the slurry with a thickness of about 60 μm on a copper current collector having a thickness of about 10 μm, dried in a hot-air drier for 0.5 hours at 100° C., dried again for 4 hours 120° C. in a vacuum condition, and then roll-pressed to manufacture a negative electrode.

The positive electrode, the negative electrode, and a polyethylene separator of 10 μm in thickness were assembled to manufacture an electrode assembly, and the electrolyte was introduced to fabricate a rechargeable lithium battery.

### Example 2

An electrolyte and a rechargeable lithium battery were fabricated by substantially the same method as that of Example 1, except that the second additive of 2 wt % was applied.

### Example 3

An electrolyte and a rechargeable lithium battery were fabricated by substantially the same method as that of Example 1, except that the second additive of 3 wt % was applied.

### Example 4

An electrolyte and a rechargeable lithium battery were fabricated by substantially the same method as that of Example 1, except that the first additive of 2 wt % was applied.

### Example 5

An electrolyte and a rechargeable lithium battery were fabricated by substantially the same method as that of Example 1, except that the first additive was not added if (e.g., when) the electrolyte was prepared.

### Comparative Example 1

An electrolyte and a rechargeable lithium battery were fabricated by substantially the same method as that of Example 1, except that no additive was added if (e.g., when) the electrolyte was prepared.

### Comparative Example 2

An electrolyte and a rechargeable lithium battery were fabricated by substantially the same method as that of Example 1, except that the second additive was not added if (e.g., when) the electrolyte was prepared.

### Evaluation Examples

A rechargeable lithium battery was evaluated by the method described herein.

### Evaluation 1: Charge and Discharge Characteristics at High Temperature

The rechargeable lithium batteries fabricated in the Examples and Comparative Examples were charged and discharged at 45° C. for 200 cycles under the conditions of 2.0 C charge (CC/CV, 4.53 V Cut-off) and 1.0 C discharge (CC, 3.0 V Cut-off), and high-temperature capacity retention rates were calculated and listed in Table 1. The high-temperature capacity retention rate was calculated according to Equation 1.

$$Equation 1$$

$$High - temperature capacity retention rate ( \% ) = ( discharge capacity after 200 cycles / initial discharge capacity ) \times 100$$

### Evaluation 2: Resistance Test

The rechargeable lithium batteries according to the Examples and Comparative Examples were charged to 4.53 V at 45° C., their initial resistance values and resistance values after 28 days at 60° C. were measured, and then resistance increase rates were calculated and listed in Table 1. The resistance values were measured by utilizing electrochemical impedance spectroscopy (EIS).

The resistance increase rate was calculated according to Equation 2.

$$Equation 2$$

$$Resistance increase rate ( \% ) = ( resistance after 28 days / initial resistance ) \times 100$$

### Evaluation 3: Gas Generation at High Temperature

The rechargeable lithium batteries according to the Examples and Comparative Examples underwent evaluation of gas generation characteristics at high temperature. The rechargeable lithium batteries according to the Examples and Comparative Examples were charged to 4.53 V at 45° C. and then left for 28 days at 60° C.

To ascertain a gas reduction effect, an initial thickness of the cell battery and a thickness of the cell battery after a 28-day standstill ware each measured, and thickness increase rates were calculated and listed in Table 1. The thickness increase rate was calculated according to Equation 3.

$$Equation 3$$

$$Thickness increase rate ( \% ) = [ \text{} ( thickness of cell after 28 days - initial thickness of cell ) / ( initial thickness of cell ) ] \times 100$$

For example, a press-type or kind thickness gauge commercially available from Mitutoyo Corporation was utilized such that a pouch cell was positioned between press plates and then a thickness of the cell was measured while being pressed with a weight of 300 gram (g). In Table 1, an initial thickness section shows thicknesses measured immediately after being released from an oven at 60° C. so as to exclude a cooling effect, and the same method was executed to measure thicknesses after being stored for 28 days in a thermostat at 60° C.

### Evaluation 4: ICP-MS Analysis (Evaluation of Transition Metal Dissolution)

The rechargeable lithium batteries according to the Examples and Comparative Examples were charged and discharged at 45° C. for 200 cycles under the conditions of 2.0 C charge (CC/CV, 4.53 V Cut-off) and 1.0 C discharge (CC, 3.0 V Cut-off), and then the method described herein was utilized to measure a dissolution amount of metal ions (e.g., cobalt (Co)).

The rechargeable lithium battery was dissembled to separate a positive electrode. Then, the separated positive electrode was placed into a 10 mL Teflon container along with the electrolyte and sealed, and then an amount of cobalt (Co) was measured by ICP-MS analysis and listed in Table 1.

TABLE 1

| | | | Resistance | |
|---|---|---|---|---|
| | Thickness | High- | increase rate | Dissolution |
| | increase | temperature | after high- | amount of |
| | rate during | capacity | temperature | transition |
| | lifetime | retention rate | storage | metal (Co) |
| | (%) | (%) | (%) | (ppm) |
| Comparative | 21.9 | 68 | 180 | 211 |
| Example 1 | | | | |
| Comparative | 18.3 | 73 | 177 | 174 |
| Example 2 | | | | |
| Example 1 | 15.8 | 74 | 175 | 133 |
| Example 2 | 13.7 | 79 | 163 | 89 |
| Example 3 | 14.1 | 84 | 154 | 95 |
| Example 4 | 14.7 | 81 | 156 | 124 |
| Example 5 | 17.0 | 71 | 170 | 156 |

### Comprehensive Evaluation

Referring to Table 1, it may be ascertained that high-temperature (60° C.) storability and resistance increase rate are more improved in the cases of Examples 1 to 4 that utilize an electrolyte to which are added the first additive and the second additive according to the present inventive concepts than in the case (i.e., Comparative Example 1) that uses an electrolyte to which not additive is added and the case (i.e., Comparative Example 2) that uses an electrolyte to which only the first additive is added. In some embodiments, it may be ascertained that high-temperature (60° C.) storability and resistance increase rate are more improved in the Examples 1 to 4 where the first additive and the second additive are combined compared to the Example 5 where the second additive is utilized alone.

Therefore, if (e.g., when) an electrolyte is added with a combination of the first additive and the second additive according to the present disclosure, it may be observed that there is an improvement in cyclic properties and lifetime efficiency of a battery at high-temperature (60° C.) storage environment.

Referring again to Table 1, it may be found that a change in cell thickness at high-temperature (60° C.) storage is greater in rechargeable lithium batteries fabricated according to Comparative Examples than in rechargeable lithium batteries fabricated according to Examples 1 to 5.

Moreover, it may be found that the rechargeable lithium batteries fabricated according to the Examples have an suitably or extremely low amount of Co dissolution. In contrast, it was confirmed that an amount of Co dissolution was remarkably greater in rechargeable lithium batteries fabricated by Comparative Examples than in rechargeable lithium batteries fabricated by the Examples. Accordingly, in rechargeable lithium batteries according to the Examples, an amount of gas generation may significantly decrease with the process of cycles.

Consequently, gas generation at a high temperature (60° C.) may be effectively suppressed or reduced in a rechargeable lithium battery that uses the compounds represented by Chemical Formulae 1 and 2 according to the present disclosure.

An electrolyte according to one or more embodiments may exhibit an effect of improvement in lifetime characteristics and stability at high pressure conditions if (e.g., when) a rechargeable battery is activated.

An electrolyte according to one or more embodiments may provide a rechargeable lithium battery with an improvement in lifetime characteristics at room and high temperatures, an effect of suppression of battery resistance increase at high-temperature standstill, and an effect of restraint of gas generation.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

While this disclosure has been described in connection with what is presently considered to be example embodiments, it is to be understood that the present disclosure is not limited to the disclosed example embodiments and is intended to cover one or more suitable modifications and equivalent arrangements included within the spirit and scope of the appended claims, and equivalents thereof. Therefore the aforementioned embodiments should be understood to be examples, but not limiting this disclosure in any way.

What is claimed is:

1. An electrolyte, the electrolyte comprising:
a non-aqueous organic solvent;
a lithium salt;
a first additive represented by Chemical Formula 1; and
a second additive represented by Chemical Formula 2, 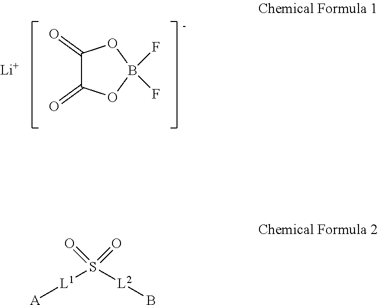
wherein, in Chemical Formula 2,
L¹ and L² are each independently a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
A and B are each independently a substituted or unsubstituted C1 to C20 alkyl group, a substituted or unsubstituted C6 to C20 aryl group, or a substituted or unsubstituted C2 to C20 heteroaryl group,
at least one selected from among A and B is a group represented by Chemical Formula A, 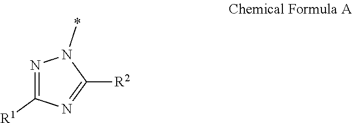
wherein, in Chemical Formula A,
R¹ and R² are each independently hydrogen, halogen, a substituted or unsubstituted C1 to C10 alkyl group, or a substituted or unsubstituted C3 to C10 cycloalkyl group, and
* is a point of connection to Chemical Formula 2, and
wherein the electrolyte being for a rechargeable lithium battery.

2. The electrolyte as claimed in claim 1, wherein at least one selected from among L¹ and L² is a substituted or unsubstituted C1 to C5 alkylene group.

3. The electrolyte as claimed in claim 1, wherein at least one selected from among L¹ and L² is a substituted or unsubstituted C2 to C5 alkylene group.

4. The electrolyte as claimed in claim 1, wherein L¹ and L² are each independently a substituted or unsubstituted C1 to C5 alkylene group.

5. The electrolyte as claimed in claim 1, wherein the second additive is represented by Chemical Formula 2-1, 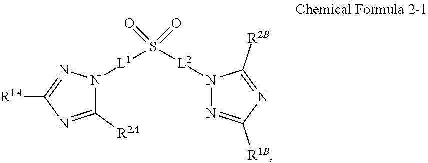
and
wherein, in Chemical Formula 2-1,
L¹ and L² are each independently a substituted or unsubstituted C2 to C5 alkylene group, and
R^{1A}, R^{1B}, R^{2A}, and R^{2B} are each independently hydrogen, halogen, a substituted or unsubstituted C1 to C10 alkyl group, or a substituted or unsubstituted C3 to C10 cycloalkyl group.

6. The electrolyte as claimed in claim 1, wherein the second additive is represented by any one selected from among compounds listed in Group 1,

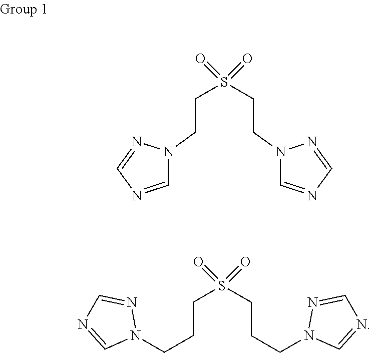 [SMILES: O=S(=O)(CCn1cncn1)CCn1cncn1 ; O=S(=O)(CCCn1cncn1)CCCn1cncn1]

7. The electrolyte as claimed in claim 1, wherein an amount of the first additive is about 0.5 wt % to about 3 wt % relative to a total weight of 100 wt % of the electrolyte.

8. The electrolyte as claimed in claim 1, wherein an amount of the second additive is about 0.5 wt % to about 5 wt % relative to a total weight of 100 wt % of the electrolyte.

9. The electrolyte as claimed in claim 1, wherein an amount weight ratio of the second additive to the first additive is about 1 to about 5.

10. The electrolyte as claimed in claim 1, wherein the non-aqueous organic solvent comprises a carbonate-based solvent,
the carbonate-based solvent comprising at least one selected from among ethylene carbonate (EC), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), propylene carbonate (PC), and butylene carbonate (BC).

11. The electrolyte as claimed in claim 1, wherein the non-aqueous organic solvent comprises a mixed solvent comprising ethylene carbonate (EC), propylene carbonate (PC), and propyl propionate (PP).

12. The electrolyte as claimed in claim 11, wherein an amount of ethylene carbonate (EC) is about 5 vol % to about 20 vol %, an amount of propylene carbonate (PC) is about 10 vol % to about 30 vol %, and an amount of propyl propionate (PP) is about 50 vol % to about 80 vol %, based on a total volume of 100 vol % of the non-aqueous organic solvent.

13. The electrolyte as claimed in claim 1, wherein the lithium salt comprises at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃.

14. The electrolyte as claimed in claim 1, wherein a concentration of the lithium salt is about 0.1 M to about 2.0 M.

15. A rechargeable lithium battery, comprising:
a positive electrode comprising a positive electrode active material;
a negative electrode comprising a negative electrode active material; and
the electrolyte as claimed in claim 1.

16. The rechargeable lithium battery as claimed in claim 15, wherein the positive electrode active material comprises at least one selected from among lithium cobalt-based oxide, lithium nickel-based oxide, lithium manganese-based oxide, lithium iron phosphate-based compounds, cobalt-free nickel-manganese-based oxide, and combinations thereof.

17. The rechargeable lithium battery as claimed in claim 15, wherein the positive electrode active material is at least one selected from among:
LiₐA_{1-b}X_{b}O_{2-c}D_{c}, wherein 0.90≤a≤1.8, 0≤b≤0.5, 0≤c≤0.05,
LiₐMn_{2-b}X_{b}O_{4-c}D_{c}, wherein 0.90≤a≤1.8, 0≤b≤0.5, 0≤c≤0.05,
LiₐNi_{1-b-c}Co_{b}X_{c}O_{2-α}D_{α}, wherein 0.90≤a≤1.8, 0≤b≤0.5, 0≤c≤0.5, 0<α<2,
LiₐNi_{1-b-c}Mn_{b}X_{c}O_{2-α}D_{α}, wherein 0.90≤a≤1.8, 0≤b≤0.5, 0≤c≤0.5, 0<α<2,
LiₐNi_{b}Co_{c}L¹_{d}GeO₂, wherein 0.90≤a≤1.8, 0≤b≤0.9, 0≤c≤0.5, 0≤d≤0.5, 0≤e≤0.1,
LiₐNiG_{b}O₂, wherein 0.90≤a≤1.8, 0.001≤b≤0.1,
LiₐCoG_{b}O₂, wherein 0.90≤a≤1.8, 0.001≤b≤0.1,
LiₐMn_{1-b}G_{b}O₂, wherein 0.90≤a≤1.8, 0.001≤b≤0.1,
LiₐMn₂G_{b}O₄, wherein 0.90≤a≤1.8, 0.001≤b≤0.1,
LiₐMn_{1-g}G_{g}PO₄, wherein 0.90≤a≤1.8, 0≤g≤0.5,
Li_{(3-f)}Fe₂(PO₄)₃, wherein (0≤f≤2), and
LiₐFePO₄, wherein (0.90≤a≤1.8),
A being Ni, Co, Mn, or a combination thereof,
X being Al, Ni, Co, Mn, Cr, Fe, Mg, Sr, V, a rare-earth element, or a combination thereof,
D being O, F, S, P, or a combination thereof,
G being Al, Cr, Mn, Fe, Mg, La, Ce, Sr, V, or a combination thereof, and
L¹ being Mn, Al, or a combination thereof.

18. The rechargeable lithium battery as claimed in claim 15, wherein the negative electrode active material comprises a carbon-based negative electrode active material, a silicon-based negative electrode active material, or a combination thereof.

19. The rechargeable lithium battery as claimed in claim 15, wherein a maximum charging voltage of the rechargeable lithium battery is equal to, or greater than, about 4.5 V.
